(19) United States
(12) Patent Application Publication
(10) Pub. No.: US 2021/0383329 A1
(43) Pub. Date: Dec. 9, 2021

(54) METHOD OF DISTRIBUTING FUNCTIONAL ELEMENT UNIT TASKS OF CROWDSOURCING-BASED PROJECT, APPARATUS THEREFOR, AND COMPUTER PROGRAM THEREFOR

(71) Applicant: CROWDWORKS INC., Seoul (KR)

(72) Inventors: Min Woo PARK, Gyeonggi-do (KR); Sung Woo CHO, Seoul (KR)

(21) Appl. No.: 17/389,339

(22) Filed: Jul. 30, 2021

Related U.S. Application Data
(63) Continuation of application No. PCT/KR2021/006858, filed on Jun. 2, 2021.

(30) Foreign Application Priority Data
Jun. 3, 2020 (KR) 10-2020-0066959

(51) Int. Cl. G06Q 10/10; G06Q 10/06

(52) U.S. Cl. CPC G06Q 10/103; G06Q 10/063118; G06Q 10/06316; G06Q 10/063114; G06Q 10/06398

(57) ABSTRACT

Provided are a method of distributing functional element unit tasks of a crowdsourcing-based project, an apparatus therefor, and a computer program therefor, wherein one task is divided into a plurality of functional element unit tasks, and the task divided into functional element units is distributed to each of a plurality of workers who each has a functional element selected as an outstanding functional element to allow each of the workers to perform only a task for an outstanding functional element of each of the workers from among a plurality of functional elements, thereby performing each functional element unit task by a worker having an outstanding work ability for a corresponding functional element to improve progress speed and work quality of a project.

### TECHNICAL FIELD

The present disclosure relates to a method of distributing functional element unit tasks of a crowdsourcing-based project, an apparatus therefor, and a computer program therefor.

### BACKGROUND ART

Recently, more and more companies have been collecting and processing large amounts of data based on crowdsourcing that engages the general public in some processes of company activities. In other words, a company opens one project and allows the general public, i.e., workers, to participate in the corresponding project to collect needed information via the results of work completed by the workers.

In detail, when one project is opened, a plurality of tasks are assigned to each of a plurality of workers. Each worker performs a plurality of assigned tasks and provides work results of the tasks. Each of a plurality of inspectors is assigned a plurality of inspection tasks for the work results, and each inspector performs the assigned inspection tasks.

Because there are many different types of projects, a worker may need only one type of work ability or may need various types of work abilities to perform a task.

In the case of a project that needs various types of work abilities of a worker, a task complexly including various elements needs to be performed. Therefore, a worker needs to have outstanding work abilities for all of various elements to provide a high-quality work result.

However, because respective workers have different outstanding fields according to interests, task performance experiences, and the like, when a task of a project needing various types of work abilities is assigned to one worker, the corresponding worker may properly perform work only in the field in which the worker outstands and may not properly perform work in the other fields. Accordingly, the work quality of the project eventually deteriorates.

### DESCRIPTION OF EMBODIMENTS

### Technical Problem

Provided is a method of distributing functional element unit tasks of a crowdsourcing-based project.

The problems to be solved by the present disclosure are not limited to the problems described above, and other problems may be present.

### Solution to Problem

According to an aspect of the present disclosure, a method of distributing functional element unit tasks of a crowdsourcing-based project may include: identifying a plurality of functional elements included in a task of a crowdsourcing-based project; on the basis of a previous project history of each of first workers, selecting, for each of first workers, one outstanding functional element from among the plurality of functional elements included in the task of the project, wherein each of the first workers includes a worker who has a previous project history for the plurality of functional elements included in the task of the project; after the outstanding functional element of each of the first workers is selected, dividing, for each task of the project, one task into a plurality of functional element units; assigning a plurality of functional element unit tasks obtained from the division to a plurality of first workers to request performance of the tasks, wherein functional element unit tasks corresponding to the outstanding functional element are assigned to the plurality of first workers; when a plurality of functional element unit work results for the functional element unit tasks are received from the plurality of first workers, merging the plurality of functional element unit work results into one work result; requesting one first inspector to perform inspection of the work result; and receiving, from the first inspector, an inspection result for the work result in a plurality of functional element units, wherein

the assigning the functional element unit tasks includes: when the plurality of functional element unit tasks have a sequential performance order, after performance of a first functional element unit task of a higher priority is completed, assigning a second functional element unit task of a lower priority to request performance of the task; and, when the plurality of functional element unit tasks do not have the sequential performance order, simultaneously assigning the plurality of functional element unit tasks to request performance of the tasks, and

the method further includes: assigning each of second workers N tasks (wherein N is a natural number greater than or equal to 1) that are not divided into a plurality of functional element units to request performance of the tasks, wherein each of the second workers includes a worker who does not have a previous project history for the plurality of functional elements included in the task of the project; when work results of the assigned N tasks are received from each of the second workers, assigning the work results of the N tasks to a plurality of inspectors to request performance of inspection; when inspection results for the work results of the N tasks are received in the plurality of functional element units from the plurality of inspectors, selecting, for each of the second workers, an outstanding functional element from among the plurality of functional elements included in the task of the project, on the basis of the inspection results for the work results of the N tasks of each of the second workers; after the outstanding functional element is selected for each of the second workers, dividing, for each task of the project, one task into the plurality of functional element units; assigning the plurality of functional element unit tasks obtained from the division to a plurality of second workers to request performance of the tasks, wherein a functional element unit task corresponding to the outstanding functional element is assigned to each of the second workers; when a plurality of functional element unit work results for the assigned functional element unit tasks are received from the plurality of second workers, merging the plurality of functional element unit work results into one work result; requesting one second inspector to perform inspection of the work result; and receiving, from the second inspector, an inspection result for the merged work result, in a plurality of functional element units.

The selecting, for each of the first workers, the outstanding functional element may include: calculating a rejection rate of each of the first workers for each of the plurality of functional elements included in the task of the project, on the basis of the previous project history of each of the first workers; and selecting, for each of the first workers, one outstanding functional element from among the plurality of functional elements included in the task of the project, on the basis of the calculated rejection rate.

The selecting, for each of the first workers, the outstanding functional element may include selecting, for each of the first workers, one outstanding functional element from among the plurality of functional elements included in the task of the project by comparing percentile values of rejection rates of each of the first workers for respectively the plurality of functional elements included in the task of the project.

The selecting, for each of the first workers, the outstanding functional element may include, when the percentile values of the rejection rates of each of the first workers for respectively the plurality of functional elements included in the task of the project include a plurality of greatest values, selecting, for each of the first workers, one outstanding functional element from among the plurality of functional elements included in the task of the project, further on the basis of a number of performed tasks of each of the first workers for each of the plurality of functional elements included in the task of the project.

The method may further include, after the outstanding functional element of each of the first workers is selected, when an inspection result of the inspector for a particular functional element unit work result is a rejection according to the inspection result for the work result, requesting a first worker who inputs the rejected functional element unit work result from among each of the first workers to perform rework.

The method may further include, when a first functional element unit task and a second functional element unit task have a sequential performance order, accumulatively calculating, for each of the first workers, a number of rejections that are input as an inspection result for a first functional element unit work result by the inspector, and giving a preset penalty to a first worker who has the accumulatively calculated number exceeding a reference number, from among each of the first workers.

The selecting, for each of the second workers, the outstanding functional element may include: calculating a rejection rate of each of the second workers for each of the plurality of functional elements included in the task of the project, on the basis of the inspection results for the work results of the N tasks; and selecting, for each of the second workers, one outstanding functional element from among the plurality of functional elements included in the task of the project, on the basis of the calculated rejection rate.

The N tasks may include a plurality of verification tasks for each of the plurality of functional elements included in the task of the project, and the selecting, for each of the second workers, the outstanding functional element may include: calculating a number of incorrect performances of each of the second workers for each of the plurality of functional elements included in the task of the project, on the basis of a plurality of verification work results from among the work results of the N tasks of each of the second workers; and selecting, for each of the second workers, one or more outstanding functional elements from among the plurality of functional elements included in the task of the project, on the basis of the number of incorrect performances of each of the second workers for each of the plurality of functional elements included in the task of the project.

According to another aspect of the present disclosure, an apparatus for distributing functional element unit tasks of a crowdsourcing-based project may include: a memory storing data associated with the project; a communication module performing communication with a plurality of workers associated with the project; and a processor processing an operation of distributing functional element unit tasks of the project, wherein the processor identifies a plurality of functional elements included in a task of the project, selects, for each of first workers, one outstanding functional element from among the plurality of functional elements included in the task of the project, on the basis of a previous project history of each of the first workers, wherein each of the first workers includes a worker who has a previous project history for the plurality of functional elements included in the task of the project, after the outstanding functional element of each of the first workers is selected, divides, for each task of the project, one task into a plurality of functional element units, assigns a plurality of functional element unit tasks obtained from the division to a plurality of first workers to request, via the communication module, performance of the tasks, wherein functional element unit tasks corresponding to the outstanding functional element are assigned to the plurality of first workers, when a plurality of functional element unit work results for the functional element unit tasks are received from the plurality of first workers via the communication module, merges the plurality of functional element unit work results into one work result, requests performance of inspection for the work result from one first inspector via the communication module, and receives, from the first inspector via the communication module, an inspection result for the work result in a plurality of functional element units, wherein the processor, upon assignment of the functional element unit tasks, when the plurality of functional element unit tasks have a sequential performance order, after performance of a first functional element unit task of a higher priority is completed, assigns a second functional element unit task of a lower priority to request performance of the task, and, when the plurality of functional element unit tasks do not have the sequential performance order, simultaneously assigns a plurality of functional element unit tasks to and request performance of the tasks, and the processor assigns N tasks (wherein N is a natural number greater than or equal to 1) that are not divided into a plurality of functional elements to each of the second workers to request, via the communication module, performance of the tasks, wherein each of the second workers includes a worker who does not have a previous project history for the plurality of functional elements included in the task of the project, when work results of the assigned N tasks are received from each of the second workers via the communication module, assigns the work results of the N tasks to a plurality of inspectors to request, via the communication module, performance of inspection, when inspection results for the work results of the N tasks are received in the plurality of functional element units from the plurality of inspectors via the communication module, selects, for each of the second workers, an outstanding functional element from among the plurality of functional elements included in the task of the project, on the basis of the inspection results for the work results of the N tasks of each of the second workers, after the outstanding functional element is selected for each of the second workers, divides, for each task of the project, one task into the plurality of functional element units, assigns a plurality of functional element unit tasks obtained from the division to a plurality of second workers to request, via the communication module, performance of the tasks, wherein a functional element unit task corresponding to the outstanding functional element is assigned to each of the second workers, when a plurality of functional element unit work results for the assigned functional element unit tasks are received from the plurality of second workers via the communication module, merges the plurality of functional element unit work results into one work result, requests performance of inspection for the work result from one second inspector via the communication module, and receives an inspect result for the merged work result in a plurality of functional element units from the second inspector via the communication module.

According to another aspect of the present disclosure, a computer program stored in a medium to be combined with a computer that is hardware to execute a method of distributing functional element unit tasks of a crowdsourcing-based project may perform: identifying a plurality of functional elements included in a task of a crowdsourcing-based project; on the basis of a previous project history of each of first workers, selecting, for each of first workers, one outstanding functional element from among the plurality of functional elements included in the task of the project, wherein each of the first workers includes a worker who has a previous project history for the plurality of functional elements included in the task of the project; after the outstanding functional element of each of the first workers is selected, dividing, for each task of the project, one task into a plurality of functional element units; assigning a plurality of functional element unit tasks obtained from the division to a plurality of first workers to request performance of the tasks, wherein functional element unit tasks corresponding to the outstanding functional element are assigned to the plurality of first workers; when a plurality of functional element unit work results for the functional element unit tasks are received from the plurality of first workers, merging the plurality of functional element unit work results into one work result; requesting one first inspector to perform inspection of the work result; and receiving, from the first inspector, an inspection result for the work result in a plurality of functional element units, wherein the assigning the functional element unit tasks includes: when the plurality of functional element unit tasks have a sequential performance order, after performance of a first functional element unit task of a higher priority is completed, assigning a second functional element unit task of a lower priority to request performance of the task; and, when the plurality of functional element unit tasks do not have the sequential performance order, simultaneously assigning the plurality of functional element unit tasks to request performance of the tasks, and the computer program further performs: assigning each of second workers N tasks (wherein N is a natural number greater than or equal to 1) that are not divided into a plurality of functional element units to request performance of the tasks, wherein each of the second workers includes a worker who does not have a previous project history for the plurality of functional elements included in the task of the project; when work results of the assigned N tasks are received from each of the second workers, assigning the work results of the N tasks to a plurality of inspectors to request performance of inspection; when inspection results for the work results of the N tasks are received in the plurality of functional element units from the plurality of inspectors, selecting, for each of the second workers, an outstanding functional element from among the plurality of functional elements included in the task of the project, on the basis of the inspection results for the work results of the N tasks of each of the second workers; after the outstanding functional element is selected for each of the second workers, dividing, for each task of the project, one task into the plurality of functional element units; assigning the plurality of functional element unit tasks obtained from the division to a plurality of second workers to request performance of the tasks, wherein a functional element unit task corresponding to the outstanding functional element is assigned to each of the second workers; when a plurality of functional element unit work results for the assigned functional element unit tasks are received from the plurality of second workers, merging the plurality of functional element unit work results into one work result; requesting one second inspector to perform inspection of the work result; and receiving, from the second inspector, an inspection result for the merged work result, in a plurality of functional element units.

### Advantageous Effects of Disclosure

According to the present disclosure described above, one task may be divided into a plurality of functional element unit tasks, and the tasks divided into the functional element units may be respectively assigned to a plurality of workers having functional elements that are respectively selected as outstanding functional elements, thereby allowing each of the workers to perform only a task for an outstanding functional element of the worker from among a plurality of functional elements.

Accordingly, each functional element unit task is performed by a worker having an outstanding work ability for the corresponding functional element, and thus, the progress speed and work quality of a project may be improved.

Effects of the present disclosure are not limited to the effects mentioned above, and unmentioned other effects will be clearly understood by one of ordinary skill in the art from the following description.

### BRIEF DESCRIPTION OF DRAWINGS

FIG. 1 is a conceptual diagram of a crowdsourcing service according to an embodiment of the present disclosure.

FIG. 2 is a flowchart illustrating a process of a crowdsourcing-based project, according to an embodiment of the present disclosure.

FIG. 3 is a flowchart of a method of distributing functional element unit tasks of a crowdsourcing-based project associated with first workers, according to an embodiment of the present disclosure.

FIG. 4 is an example view illustrating the selection of an outstanding functional element from among a plurality of functional elements, on the basis of a percentile value, according to an embodiment of the present disclosure.

FIG. 5 is an example view illustrating the selection of an outstanding functional element from among a plurality of functional elements, on the basis of a percentile value and the number of performed tasks, according to an embodiment of the present disclosure.

FIG. 6 is an example view illustrating the division of one task into functional element units, according to an embodiment of the present disclosure.

FIG. 7 is an example view illustrating the assignment of functional element unit tasks corresponding to an outstanding functional element to a plurality of first workers, according to an embodiment of the present disclosure.

FIG. 8 is an example view illustrating merging of a plurality of functional element unit work results into one work result, according to an embodiment of the present disclosure.

FIG. 9 is an example view illustrating the assignment of merged one work result to one inspector, according to an embodiment of the present disclosure.

FIG. 10 is an example view illustrating the reception of inspection results in a plurality of functional element units from an inspector, according to an embodiment of the present disclosure.

FIG. 11 is a flowchart of a method of distributing functional element unit tasks of a crowdsourcing-based project associated with a second worker, according to an embodiment of the present disclosure.

FIGS. 12A and 12B are example views illustrating a point in time when outstanding functional elements of a first worker and a second worker are selected, according to an embodiment of the present disclosure.

FIG. 13 is a block diagram illustrating an apparatus for distributing functional element unit tasks of a crowdsourcing-based project, according to an embodiment of the present disclosure.

### MODE OF DISCLOSURE

Advantages and features of the disclosure, and methods of achieving thereof will become apparent with reference to the embodiments described below in detail in conjunction with the accompanying drawings. The disclosure may, however, be embodied in many different forms and should not be construed as being limited to the embodiments set forth herein; rather, these embodiments are provided so that this disclosure will be thorough and complete, and will fully convey the concept of the disclosure to those skilled in the art, and the disclosure is merely defined by the scope of claims.

The terminology used herein is for the purpose of describing the embodiments and is not intended to limit the disclosure. As used herein, the singular forms are intended to include the plural forms as well, unless the context clearly indicates otherwise. The terms “comprises” and/or “comprising” when used in this specification do not preclude the presence or addition of one or more other elements in addition to stated elements. Like reference numerals refer to like elements throughout. As used herein, the term “and/or” includes any and all combinations of one or more of the associated listed items. Although the terms “first,” “second,” etc. may be used herein to describe various elements or components, these elements or components should not be limited by these terms. These terms are only used to distinguish one element or component from another element or component. Thus, a first element or component discussed below may be termed a second element or component without departing from the scope of example embodiments.

Unless otherwise defined, all terms (including technical and scientific terms) used herein have the same meanings as commonly understood by one of ordinary skill in the art to which example embodiments belong. Terms, such as those defined in commonly used dictionaries, will not be interpreted in an idealized or overly formal sense unless expressly so defined herein.

Hereinafter, embodiments of the present disclosure will be described in detail with reference to the accompanying drawings.

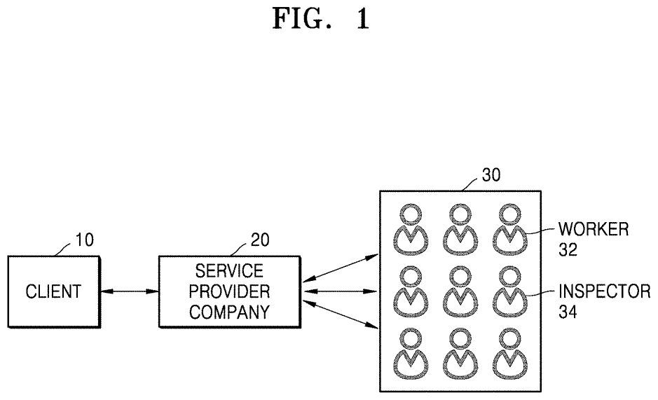

FIG. 1 is a conceptual diagram of a crowdsourcing service according to an embodiment.

Referring to FIG. 1, a crowdsourcing service is performed by constituting a client 10, a service provider company 20, and the public 30.

The client 10 refers to a company or individual that commissions a crowdsourcing-based project (hereinafter, referred to as a project).

The client 10 commissions the project, for the collection of source data for the generation of artificial intelligence learning data, data annotation, or the like. Data generated via the project may be used as learning data for any machine learning such as supervised learning, unsupervised learning, or reinforcement learning. The collection of the source data refers to the collection of raw data such as the collection of recorded voice and the collection of photos. The data annotation refers to inputting associated annotation data into source data such as text, photos, and video. For example, the data annotation may include finding an entity in given text, finding a similar sentence, and the like but is not limited thereto. The type of project described above is only an embodiment, and various types of projects may be handled in the disclosure according to the design of a client.

The service provider company 20 refers to a company that provides a crowdsourcing service.

When receiving, from the client 10, a request for a product or service project, the service provider company 20 assigns work on the corresponding project to the public 30 and receives the results of the work from the public 30. The service provider company 20 provides the client 10 with final outputs extracted on the basis of the results of work.

Here, the service provider company 20 provides the client 10 and the public 30 with crowdsourcing services via a crowdsourcing platform (hereinafter, referred to as a platform). In other words, when the service provider company 20 receives a project request from the client 10, the service provider company 20 opens a project on the platform. When the service provider company 20 receives, from the public 30, the results of the work on the opened project, the service provider company 20 may end the corresponding project on the platform, extract final outputs, and provide the extracted final outputs to the client 10.

The public 30 refers to the general public who participates in the project opened on the platform. Here, the public 30 may participate in the project opened on the platform, via an application, website, or the like provided by the service provider company 20.

The public 30 includes a worker 32 and an inspector 34.

The worker 32 determines to participate in a particular project from among a plurality of projects opened on the platform. The worker 32 performs work such as the collection of source data and data annotation, and transmits the same to the platform.

The inspector 34 determines to participate in a particular project from among the plurality of projects opened on the platform. The inspector 34 performs inspection on the results of work performed by the worker 32. The inspector 34 may perform inspection pass processing or rejection processing as the results of the inspection performance, and may input the reasons for the rejections when performing rejection processing. In the cases of inspection passes, reworks and subsequent reinspection are not needed, and thus, inspection passes mean the same as the completion of inspection.

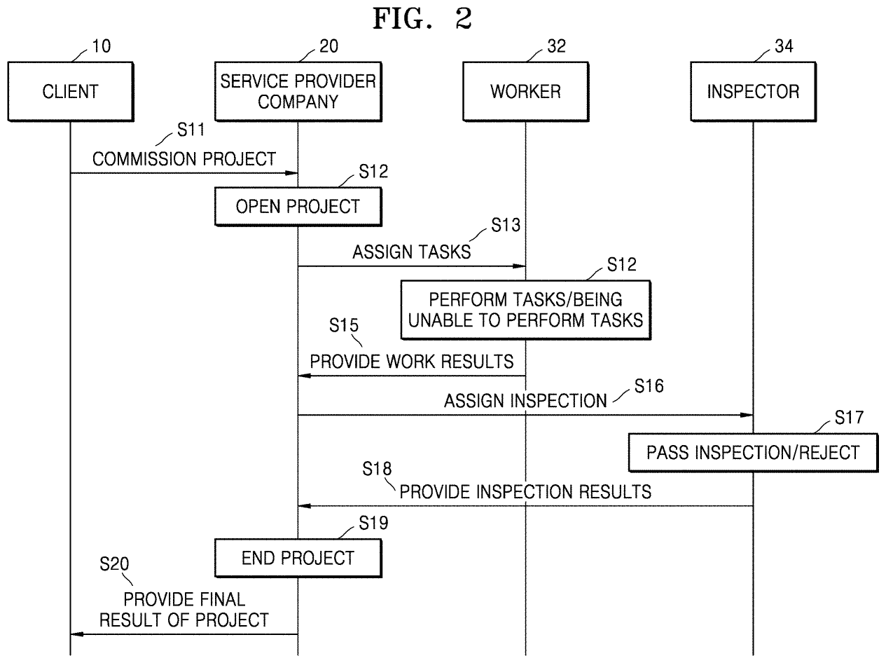

FIG. 2 is a flowchart illustrating a process of a crowdsourcing-based project according to an embodiment.

In operation S11, a client 10 commissions one or more projects to a service provider company 20.

In operation S12, the service provider company 20 opens the commissioned projects on a platform. Here, before opening a project, the service provider company 20 may determine a grade of the project by considering a level of difficulty of the corresponding project and the like. In other words, the service provider company 20 may determine to expose the corresponding project to the public 30 having a certain grade or higher, according to the level of difficulty. Accordingly, the reliability of work results of a project may be improved.

In operation S13, the service provider company 20 assigns tasks to a worker 32 having a corresponding grade or higher, according to the grade of the project, and requests to perform the tasks.

In operation S14, the worker 32 performs the assigned tasks. Here, the worker 32 may not perform a task that may not be performed for some reason and input a reason for not being able to perform the task.

In operation S15, the service provider company 20 receives work results from the worker 32 and, in operation S16, assigns inspection work for the corresponding work results to an inspector 34 and requests inspection.

In operation S17, the inspector 34 performs the assigned inspection. Here, the inspector 34 determines an inspection pass when a task is determined as being appropriately performed and processes the task as a rejection when the task is determined, via inspection work, as being incorrectly performed. When processing the rejection, the inspector 34 inputs a reason for the rejection of the task being determined as being incorrectly performed.

In operation S18, the service provider company 20 receives the results of inspection from the inspector 34.

When the results of inspection are inspection passes, the service provider company 20 uses the corresponding work results as valid data and, on the basis of the valid data, extracts final outputs at the end of the project.

When the results of inspection are rejection processing, the service provider company 20 may internally re-perform inspection, or may re-assign tasks to the worker 32 and request to perform rework. Reinspection by an inspector is needed upon rework.

The service provider company 20 terminates the corresponding project in operation S19 when a project period ends or sufficient valid data is secured, and, on the basis of the secured valid data, calculates the final results and provides the final results to the client 10 in operation S20.

Here, before the project ends, the service provider company 20 evaluates the performance results of the worker 32 and the inspector 34, calculates work cost and inspection cost according to the evaluation, and pays the work cost and inspection cost to the worker 32 and the inspector 34.

FIGS. 1 and 2 simply illustrate the client 10, the service provider company 20, the worker 32, and the inspector 34. However, the client 10, the service provider company 20, the worker 32, and the inspector 34 may refer to computer apparatuses or telecommunication devices such as smartphones, tablets, personal digital assistants (PDAs), laptops, desktops, and servers operated by respective participants.

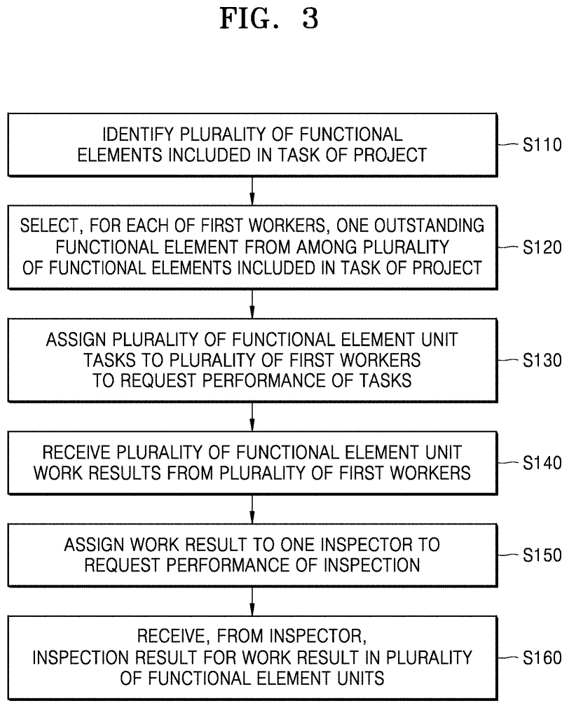

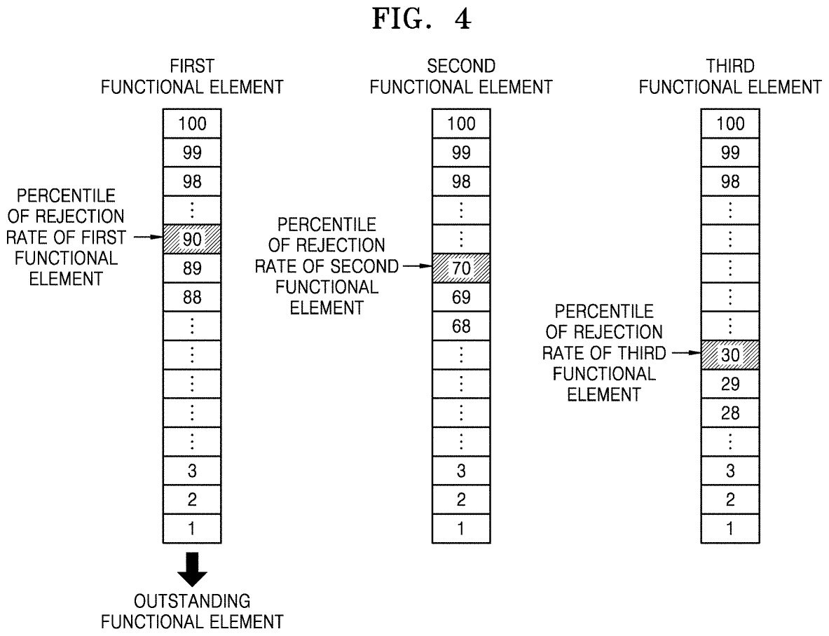

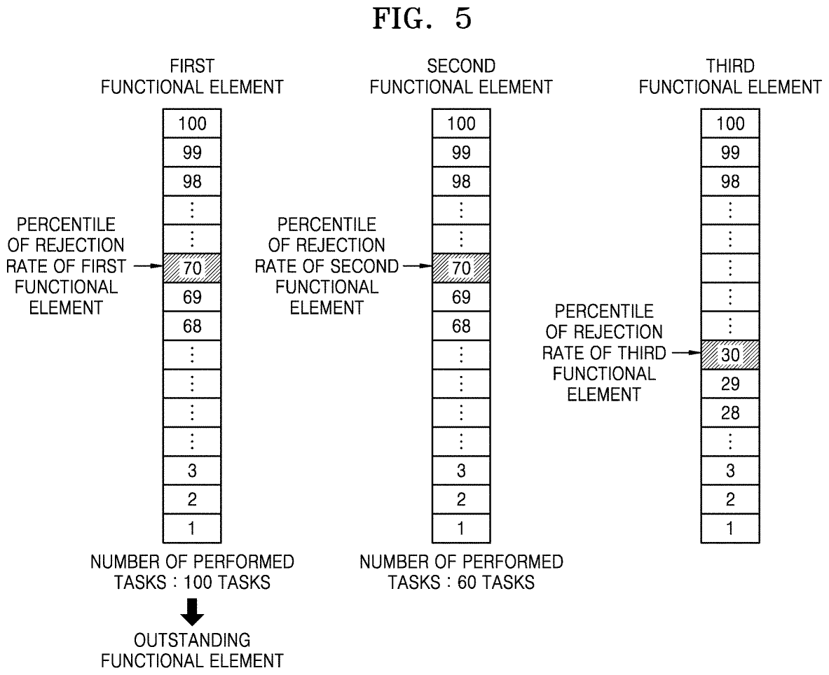

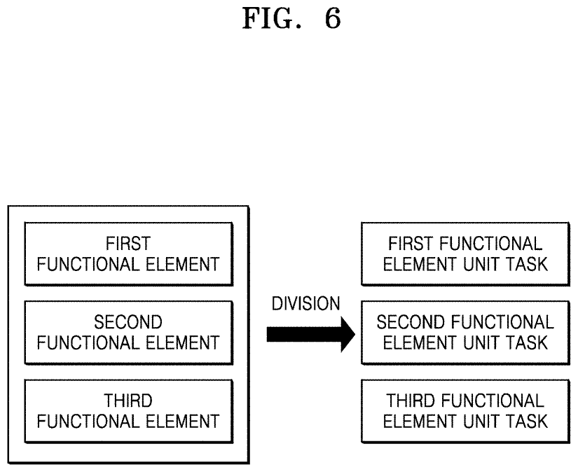

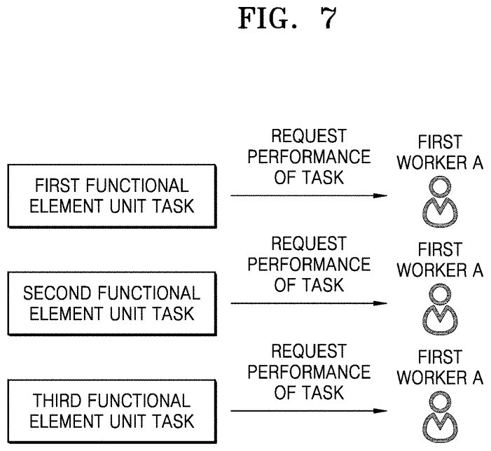

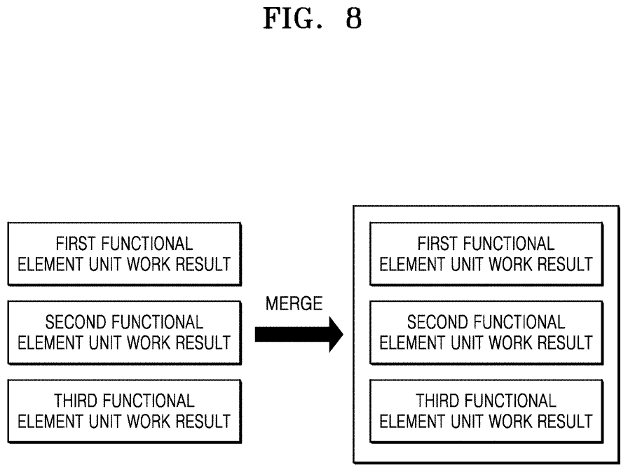

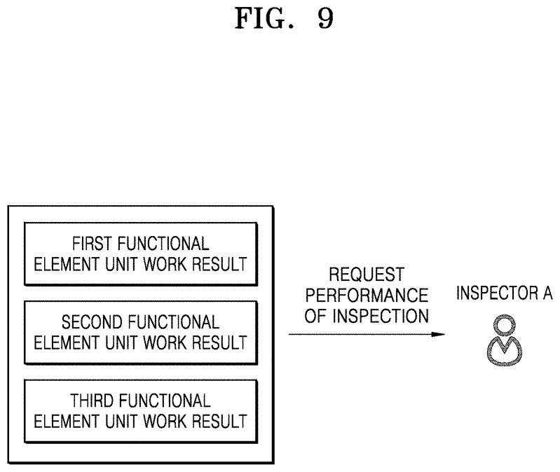

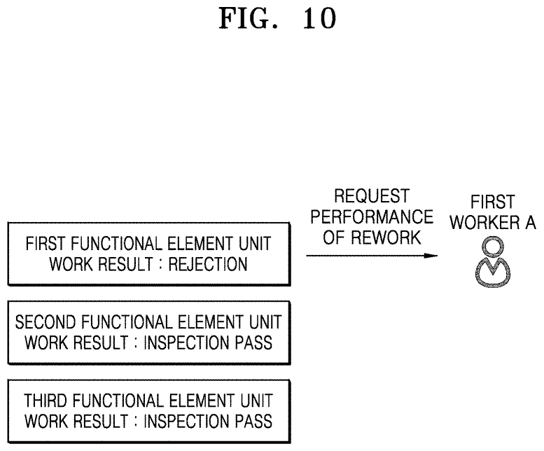

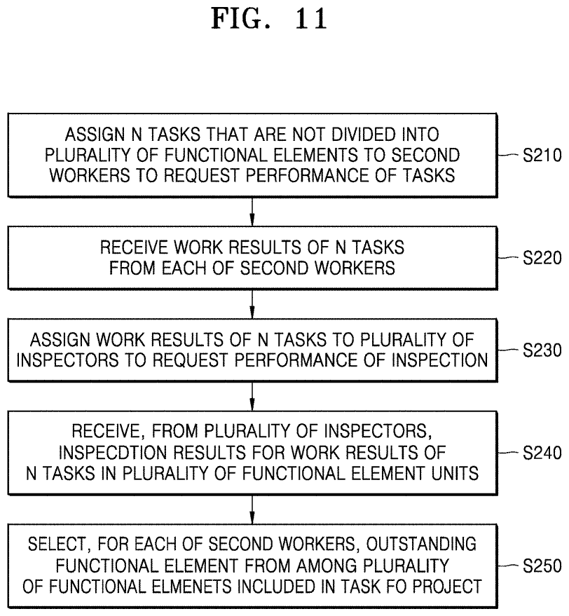

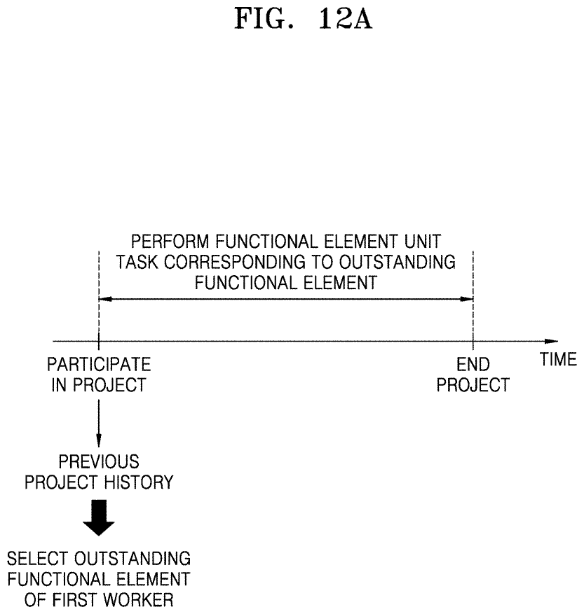

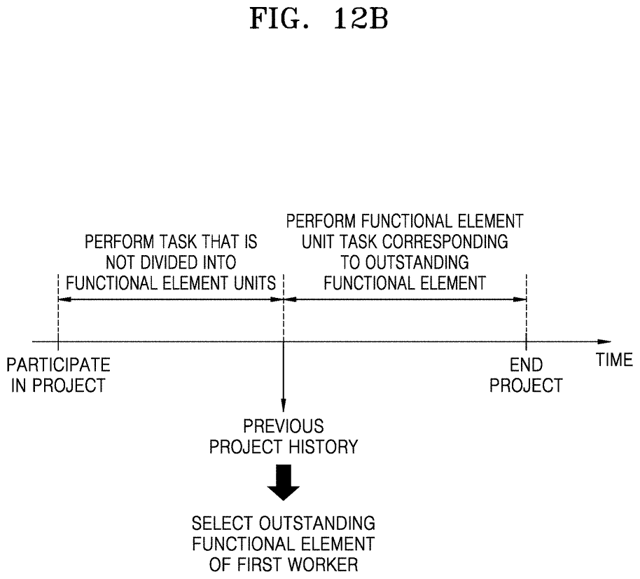

FIG. 3 is a flowchart of a method of distributing functional element unit tasks of a crowdsourcing-based project associated with first workers, according to an embodiment of the present disclosure. FIG. 4 is an example view illustrating the selection of an outstanding functional element from among a plurality of functional elements, on the basis of a percentile value, according to an embodiment of the present disclosure. FIG. 5 is an example view illustrating the selection of an outstanding functional element from among a plurality of functional elements, on the basis of a percentile value and the number of performed tasks, according to an embodiment of the present disclosure. FIG. 6 is an example view illustrating the division of one task into functional element units, according to an embodiment of the present disclosure. FIG. 7 is an example view illustrating the assignment of functional element unit tasks corresponding to an outstanding functional element to a plurality of first workers, according to an embodiment of the present disclosure. FIG. 8 is an example view illustrating merging of a plurality of functional element unit work results into one work result, according to an embodiment of the present disclosure. FIG. 9 is an example view illustrating the assignment of merged one work result to one inspector, according to an embodiment of the present disclosure. FIG. 10 is an example view illustrating the reception of inspection results in a plurality of functional element units from an inspector, according to an embodiment of the present disclosure. FIG. 11 is a flowchart of a method of distributing functional element unit tasks of a crowdsourcing-based project associated with a second worker, according to an embodiment of the present disclosure. FIGS. 12A and 12B are example views illustrating a point in time when outstanding functional elements of a first worker and a second worker are selected, according to an embodiment of the present disclosure.

It may be understood that operations illustrated in FIGS. 3 through 11 are performed by a platform server (hereinafter, a server) operated by the service provider company 20, but the operations are not limited thereto.

Also, a plurality of workers 32 or a plurality of inspectors 34 perform tasks by using certain terminal apparatuses. The terminal apparatuses of the workers 32 or the inspectors 34 may be computer apparatuses or telecommunication devices such as smartphones, tablets, personal digital assistants (PDAs), laptops, or desktops but not limited thereto.

Referring to FIG. 3, in operation S110, the server identifies a plurality of functional elements included in a task of a crowdsourcing-based project (hereinafter, a project).

The functional elements are determined on the basis of a work tool for performing the project, and the work took is a tool provided by the project and used by workers 32 to perform tasks requested by the project.

For example, when a bounding box tool for a bounding task, an input box tool for a transfer task, and a make step tool for a classification task are needed to perform tasks of a project, the tasks of the corresponding project may be classified as including a bounding functional element, a transfer functional element, and a classification functional element.

In an existing case, a task including a plurality of functional elements is assigned to one worker 32 to request the performance of the task. The worker 32 who is assigned the task including the plurality of functional elements needs to perform all of the task for the plurality of functional elements regardless of a work ability. Accordingly, the worker 32 outstandingly performs work for a particular functional element, but does not appropriately perform work for a particular functional element, thereby decreasing the work quality of a project.

In an embodiment of the present disclosure, when a task of a project includes a plurality of functional elements, an outstanding functional element of each worker 32 may be selected, and, on the basis of same, functional element unit tasks may be respectively distributed to a plurality of workers, thereby allowing each worker 32 to work only on a functional element for which the corresponding worker exhibits an outstanding work ability.

Here, a plurality of workers 32 who participate in a project may have or may not have a history of performing work in a previous project, for a plurality of functional elements included in a task of the project.

Therefore, in an embodiment of the present disclosure, an outstanding functional element of a worker (hereinafter, a first worker) who has a previous project history for a plurality of functional elements included in a task of a project and an outstanding functional element of a worker (hereinafter, ra second worker) who does not have a previous project history for a plurality of functional elements included in a task of the project may be selected in different methods.

Hereinafter, selecting an outstanding functional element of a first worker and distributing a task in functional element units will be described.

Also, hereinafter, for convenience, a plurality of functional elements included in a task of a project will be described as being three (a first functional element, a second functional element, and a third functional element) but are not limited thereto.

As described above, after identifying the plurality of functional elements included in the task of the project in operation S110, for a first worker who has a previous project history for the plurality of functional elements from among workers entering the project, the server selects, for each first worker, one outstanding functional element from among the plurality of functional elements included in the task of the project, on the basis of a previous project history of each first worker in operation S120.

In detail, the server calculates a rejection rate of each first worker for each of the plurality of functional elements included in the task of the project, on the basis of a previous project history of each first worker.

Here, the previous project history refers to data that is stored as the worker 32 participates in a project in the past and performs a task. For example, the previous project history may include information about participating projects, working hours, a rejection rate, an inspection pass rate, and the like.

The server may extract one or more previous projects including one or more functional elements of a project in which each first worker currently participates, from among previous projects in which each first worker participates, and calculate a rejection rate of each first worker for each of the functional elements by using task performance-related data in the extracted one or more previous projects.

The server selects, for each first worker, one outstanding functional element from among the plurality of functional elements included in the task of the project, on the basis of the rejection rate of each first worker for each of the plurality of functional elements included in the task of the project.

According to an embodiment, the server may select, for each first worker, one outstanding functional element from among a plurality of functional elements included in a task of a project by comparing percentile values of rejection rates of each first worker for respectively a plurality of functional elements included in a task of a project.

Percentile refers to the ranking when the size of a group is assumed to be 100. For example, a case where a rejection rate of a particular functional element of a particular first worker is 30%, and a percentile value of the rejection rate 30% is 50 indicates that the particular first worker is located, for the particular functional element, in the middle from among all workers of a corresponding project.

Percentile values are compared to relatively evaluate a work ability of a first worker by reflecting different difficulty levels of respective functional elements and the different numbers of tasks performed by workers.

Referring to FIG. 4, when a rejection rate of a first functional element calculated on the basis of a previous project history of a particular first worker is 15%, a rejection rate of a second functional element is 10%, and a rejection rate of a third functional element is 30%, a percentile value of the rejection rate of the first functional element is 90, a percentile value of the second functional element is 70, and a percentile value of the rejection rate of the third functional element is 30. In other words, the particular first worker is located, for the first functional element, in the top 10% of all workers, is located, for the second functional element, in the top 30% of all the workers, and is located, for the third functional element, in the lower 30% of all the workers. Accordingly, an outstanding functional element of the particular first worker is selected as a first functional element having the highest percentile value.

When only the rejection rates of the respective functional elements are compared, the rejection rate of the second functional element is the lowest. Therefore, the outstanding functional element of the particular first worker may be selected as a second functional element. However, the same does not reflect a difficulty level of each functional element, and thus may not be considered accurate. A rejection rate of a functional element having a low difficulty level may be calculated to be low. Therefore, even when the rejection rate of the functional element having the low difficulty level is the lowest, the particular first worker may not be determined as working more outstandingly than all workers for a corresponding functional element from among a plurality of functional elements. Therefore, as described above, by comparing percentile values of rejection rates of respective functional elements, a work ability of a particular first worker for each functional element may be relatively determined compared to those of all workers.

Here, when percentile values of rejection rates of each first worker for a plurality of functional elements included in a task of a project have a plurality of greatest values, the server selects for each first worker, one outstanding functional element from among the plurality of functional elements included in the task of the project, further on the basis of the number of performed tasks of each first worker for respectively the plurality of functional elements included in the task of the project.

In other words, when a plurality of functional elements have the highest percentile value, the server selects, as an outstanding functional element, a function element including the larger number of performed tasks of a first worker from among the plurality of functional elements.

Referring to FIG. 5, a percentile value of a rejection rate of a first functional element and a percentile value of a rejection rate of a second functional element are the highest and the same at 70. The number of performed tasks of the first functional element is 100, and the number of performed tasks of the second functional element is 60, and thus, an outstanding element of a particular first worker is selected as a first functional element including the larger number of performed tasks.

In the above description, an outstanding functional element of each first worker is selected by comparing workers who participate in the same project. However, the selection is not limited thereto, and an outstanding functional element of a first worker may be selected by comparing with all workers who are registered in a crowdsourcing platform.

After the outstanding functional element of the first worker is selected, the following process is performed for each task of a project.

Referring to FIG. 3 again, the server divides one task into a plurality of functional element units, and assigns a plurality of functional element unit tasks to a plurality of first workers to request the performance of the tasks. Here, in operation S130, the server allows a functional element unit task corresponding to an outstanding functional element to be assigned to each first worker.

Referring to FIG. 6, one task including a first functional element, a second functional element, and a third functional element may be divided into a first functional element unit task, a second functional element unit task, and a third functional element unit task, respectively.

As a result of selecting an outstanding functional element for each first worker from among a first functional element, a second functional element, and a third functional element, when an outstanding functional element of a first worker A is selected as a first functional element, an outstanding functional element of a first worker B is selected as a second functional element, and an outstanding functional element of a first worker C is selected as a third functional element, as shown in FIG. 7, the server may assign a first functional element unit task to the first worker A to request the performance of the task, assign a second functional element unit task to the first worker B to request the performance of the task, and assign a third functional element unit task to the first worker C to request the performance of the task.

According to an embodiment, when a plurality of functional element unit tasks have a sequential performance order, after the performance of a first functional element unit task of a higher priority is completed, the server may assign a second functional element unit task of a lower priority to request the performance of the task.

In other words, when a first functional element unit task, a second functional element unit task, and a third functional element unit task have a sequential performance order, the server assigns the first functional element unit task having the first order to the first worker A having a first functional element as an outstanding functional element to request the performance of the task. When the first worker A completes the performance of the first functional element unit task, the server assigns a second functional element unit task having a next order to the first worker B having a second functional element as an outstanding functional element to request the performance of the task. When the first worker B completes the performance of the second functional element unit task, the server assigns a third functional element unit task having a next order to the first worker C having a third functional element as an outstanding functional element to request the performance of the task.

According to another embodiment, when a plurality of functional element unit tasks have a sequential performance order, the server may allow a work screen of each first worker to be activated according to the order of performing tasks.

In other words, when a first functional element unit task, a second functional element unit task, and a third functional element unit task have a sequential performance order, the server activates a work screen of the first worker A having a first functional element as an outstanding functional element to enable the first functional element unit task to be performed (work screens of the first workers B and C are inactivated). When the first worker A completes the performance of the first functional element unit task, the server activates the work screen of the first worker B having a second functional element as an outstanding functional element to enable a second functional element unit task having a next order to be performed (the work screens of the first workers A and C are inactivated). When the first worker B completes the performance of the second functional element unit task, the server activates the work screen of the first worker C having a third functional element as an outstanding functional element to enable a third functional element unit task having a next order to be performed (the work screens of the first works A and B are inactivated).

According to another embodiment, when a plurality of functional element unit tasks do not have a sequential performance order, the server may simultaneously assign the plurality of functional element unit tasks to request the performance of the tasks.

In other words, when a first functional element unit task, a second functional element unit task, and a third functional element unit task do not have a sequential performance order, the server simultaneously assigns the first functional element unit task to the first worker A having a first functional element as an outstanding functional element, assigns the second functional element unit task to the first worker B having a second functional element as an outstanding functional element, and assigns the third functional element unit task to the first worker C having a third functional element as an outstanding functional element.

In operation S140, the server receives a plurality of functional element unit work results from a plurality of first workers.

In other words, when assigning a first functional element unit task to the first worker A having a first functional element as an outstanding functional element, assigning a second functional element unit task to the first worker B having a second functional element as an outstanding functional element, and assigning a third functional element unit task to the first worker C having a third functional element as an outstanding element, the server receives a first functional element unit work result from the first worker A, receives a second functional element unit work result from the first worker B, and receives a third functional element unit work result from the first worker C.

After receiving all of functional element unit work results from the respective first workers, the server merges a plurality of functional element unit work results into one work result, and assigns the work result to one inspector to request the performance of inspection in operation S150, and receives, from the inspector, an inspection result for the work result in a plurality of functional element units in operation S160.

The server merges, into one work result, a plurality of functional element unit tasks respectively received from a plurality of first workers and requests one inspector 34 to perform inspection.

Referring to FIG. 8, the server merges, into one work result, a first functional element unit work result, a second functional element unit work result, and a third functional element unit work result received from three first workers. Referring to FIG. 9, the server assigns merged one work result to an inspector A to request the performance of inspection.

The inspector A inspects the assigned one work result, and performs inspection in each functional element unit. In other words, the inspector A performs inspection, as inspection passes or rejections, for a first functional element unit work result, a second functional element unit work result, and a third functional element unit work result, respectively.

According to an inspection result for the work result, when the inspector inputs, as a rejection, an inspection result for a particular functional element unit work, the server requests a first worker who inputs the rejected functional element unit work result to perform rework.

Referring to FIG. 10, when an inspector A inputs, as a rejection, an inspection result only for a first functional element unit work result from among the first functional element unit work result, a second functional element unit work result, and a third functional element unit work result, the server requests only a first worker A who performs the first functional element unit work result to perform rework for a first functional element unit task.

Here, a first functional element unit task, a second functional element unit task, and a third functional element unit task do not have a sequential performance order, respective work results may be individually inspected. Therefore, although one functional element unit work result is rejected, inspection results for the other functional element unit work results are not affected at all. Therefore, when a first functional element unit work result is rejected, and a second functional element unit work result and a third functional element unit work result pass inspection, only a first worker A who performs a first functional element unit task performs rework, and first workers B and C who perform a second functional element unit task and a third functional element unit task do not need to perform rework.

In contrast, when a first functional element unit task, a second functional element unit task, and a third functional element unit task have a sequential performance order, respective work results are linked and inspected. Therefore, an inspection result for a functional element unit work result of a higher priority affects an inspection result for a functional element unit work result of a lower priority. Therefore, when a first functional element unit task of a higher priority is rejected, in addition to a first worker A who performs the first functional element unit task, a first worker B who performs a second functional element unit task of a lower priority and a first worker C who performs a third functional element unit task of a lower priority also need to perform rework.

In this case, even though a first worker performs a task appropriately according to a functional element unit work result of a higher priority, the first worker who performs a functional element unit task of a lower priority is rejected. In other words, a first worker who performs a functional element unit task of a lower priority suffers damage due to an error of a first worker who performs a functional element unit task of a higher priority. As a result, compensation for the labor of a first worker of a lower priority is not done properly, and thus, the first worker of the lower priority leaves a project, thereby affecting the operation of the project.

Accordingly, to solve the above drawbacks, in some embodiments of the present disclosure, although not clearly shown in FIG. 3, the method of distributing functional element unit tasks of a crowdsourcing-based project may further include an operation, when a first functional element unit task and a second functional element unit task have a sequential performance order, accumulatively calculating, for each first worker, the number of rejections that are input by an inspector as an inspection result for a first functional element unit work result and giving a certain penalty to a first worker who has the accumulatively calculated number exceeding a reference number.

When the reference number is five times, and the number of rejections of a work result of a first worker who performs a functional element unit task of a higher priority exceeds five times, a certain penalty is given to the corresponding first worker.

For example, the server may give a work limit penalty to a first worker who has the accumulatively calculated number exceeding five times (who is no longer able to perform a task in a corresponding project or for a certain period of time).

Hereinafter, the selection of an outstanding functional element of a second worker and the distribution of a task in functional element units will be described.

Also, hereinafter, for convenience, a plurality of functional elements included in a task of a project will be described as being three (a first functional element, a second functional element, and a third functional element) but are not limited thereto.

As described, after identifying the plurality of functional elements included in the task of the project in operation S110, for a second worker who does not have a previous project history for a plurality of functional elements from among workers who enter the project, referring to FIG. 11, the server assigns the second worker N tasks (wherein N is a natural number greater than or equal to 1) that are not divided into a plurality of functional element units to request the performance of the tasks in operation S210, receives work results of the N tasks from each second worker in operation S220, assigns the work results of the N tasks to a plurality of inspectors to request the performance of inspection in operation S230, receives, from the plurality of inspectors, inspection results for the work results of the N tasks in a plurality of functional element units in operation S240, and, on the basis of the inspection results for the work results of the N tasks of each second worker, selects, for each second worker, an outstanding functional element from among the plurality of functional elements included in the task of the project in operation S250.

In other words, because a second worker does not have a previous project history for a plurality of functional elements, the server may not determine a work ability of the second worker. Therefore, the server allows the second worker to perform, for initial N tasks, work on all functional elements, and identifies a functional element for which the second worker exhibits an outstanding work ability, according to an inspection result for a work result of each functional element.

In an embodiment, the server may select, for each second worker, an outstanding functional element of each second worker, on the basis of rejection rates of work results of N tasks, for each functional element.

In detail, the server calculates a rejection rate of each second worker for each of a plurality of functional elements included in a task of a project, on the basis of inspection results for work results of N tasks of each second worker, and selects, for each second worker, one outstanding functional element from among the plurality of functional elements included in the task of the project, on the basis of the rejection rate of each second worker for each of the plurality of functional elements included in the task of the project.

The server may select, for each second worker, one outstanding functional element from among the plurality of functional elements include in the task of the project by comparing percentile values of the rejection rates of each second worker for each of the plurality of functional elements included in the task of the project.

In other words, like a first worker, the server may select, as an outstanding functional element of each second worker, a functional element having the highest percentile value by comparing a percentile value of a rejection rate of each second worker for each functional element with percentile values of rejection rates of all workers for each functional element of a corresponding project.

When percentile values of rejection rates of each second worker for each of a plurality of functional elements included in a task of a project includes a plurality of greatest values, the server selects, for a second worker, an outstanding functional element further on the basis of the number of workers having corresponding functional elements selected as outstanding functional elements, rather than further on the basis of the number of performed tasks (because the second worker performs all of N tasks) like a first worker.

In other words, when a plurality of functional elements have the highest percentile values, the server selects, as an outstanding functional element, a functional element to which the smaller number of workers are matched (i.e., a corresponding functional element that is selected, for the smaller number of workers, as an outstanding functional element), from among a plurality of functional elements.

The above description, an outstanding functional element of each second worker is selected by comparing workers who currently participate in the same project but is not limited thereto. An outstanding functional element of a second worker may be selected by comparing with all workers registered in a crowdsourcing platform.

In another embodiment, the server may select an outstanding functional element of each second worker by using a verification task. In this case, N tasks include a plurality of verification tasks for each of a plurality of functional elements included in a task of a project.

The server randomly includes a plurality of verification tasks having determined correct answers, for each of a plurality of functional elements from among N tasks, assigns the verification tasks to a second worker, and determines whether or not the second worker performs the verification tasks in the same way as the correct answers. Because a verification task has a determined correct answer, whether or not a second worker appropriately performs a task may be determined on the basis of an input work result, without a need for inspection by an inspector. Therefore, an outstanding functional element of the second worker may be selected faster than in a method using a rejection rate as described above.

Here, one task may include a verification task for each of one or more functional elements. In other words, when functional elements are three, one task may include one functional element verification task, may include two functional element verification tasks, or may include three functional element verification tasks.

The server calculates the number of incorrect performances of each second worker for each of a plurality of functional elements included in a task of a project, on the basis of a plurality of verification work results of each second worker from among work results of N tasks.

For example, when 50 tasks (N tasks) each include ten verification tasks for each functional element, the server calculates, for each functional element, the number of incorrect answers of a second worker for each of the ten verification tasks.

When one task includes a first functional element, a second functional element, and a third functional element, and a particular second worker incorrectly performs three out of ten first functional element verification tasks, incorrectly performs six out of ten second functional element verification tasks, and eight out of ten third functional element verification tasks, the number of incorrect performances of the particular second worker for the first functional element may be calculated as three times, the number of incorrect performances for the second functional element may be calculated as six times, and the number of incorrect performances for the third functional element may be calculated as eight times.

The server selects, for each second worker, one or more outstanding functional elements from among a plurality of functional elements included in a task of a project, on the basis of the number of incorrect performances of each second worker for each of the plurality of functional elements included in the task of the project.

In detail, the server rejects, from an outstanding functional element, a functional element having the number of incorrect performances greater than or equal to a reference number, and selects an outstanding element from among functional elements less than the reference number.

For example, when a reference number is five times, and the number of incorrect performances of a particular second worker for a first functional element is calculated as three times, the number of incorrect performances for a second functional element is calculated as six times, and the number of incorrect performances for a third functional element is calculated as eight times, the second functional element and the third functional element having the numbers of incorrect performances greater than or equal to five times are rejected from outstanding functional elements, and the first functional element having the number of incorrect performances less than five times is selected as an outstanding functional element.

As another example, when the reference number is five times, and the number of incorrect performances of a particular second worker for a first functional element is calculated as two times, the number of incorrect performances for a second functional element is calculated as four times, and the number of incorrect performances for a third functional element is calculated as eight times, from among the first functional element and the second functional element having the numbers of incorrect performances less than five times, the first functional element having the less number of incorrect performances is selected as an outstanding functional element of the particular second worker.

As another example, when the reference number is five times, and the number of incorrect performances of a particular second worker for a first functional element is calculated as two times, the number of incorrect performances for a second functional element is calculated as two times, and the number of incorrect performances for a third functional element is calculated as eight times, from among the first functional element and the second functional element having the numbers of incorrect performances that are less than five times and are the same, a functional element having a lower rejection rate for work results of N tasks is selected as an outstanding functional element. For example, when a rejection rate of a first functional element for N tasks is 3%, and a rejection rate of a second functional element for the N tasks is 7%, the first functional element having the lower rejection rate is selected as an outstanding functional element of a particular second worker.

As another example, when a reference number is five times, and the number of incorrect performances of a particular second worker for a first functional element is calculated as six times, the number of incorrect performances for a second functional element is calculated as six times, and the number of incorrect performances for a third functional element is calculated as eight times, the first functional element, the second functional element, and the third functional element all have the number of incorrect performances greater than or equal to five times. Therefore, the first functional element, the second functional element, and the third functional element are all excluded from an outstand functional element. As described above, when all functional elements are rejected, a particular second worker may no longer be able to work on a corresponding project.

After an outstanding functional element of a second worker is selected, the same process as operations S130 through S160 is performed on each task of a project.

In other words, the server divides one task into a plurality of functional element units, and assigns a plurality of functional element unit tasks to a plurality of second workers to request the performance of the tasks, but allows a functional element unit task corresponding to an outstanding functional element to be assigned to each of the second workers. The server receives a plurality of functional element unit work results from the plurality of second workers. The server merges the plurality of functional element unit work results into one work result, and assigns the work result to one inspector to request the performance of inspection. The server receives, from the inspector, an inspection result for the work result in a plurality of functional elements units. The details are the same as those described in operations S130 through S160.

Referring to FIG. 12A, a first worker who has a previous project history for a plurality of functional elements participates in a project, and simultaneously, an outstanding functional element of the first worker is selected on the basis of the previous project history. Therefore, the first worker is assigned only a task for the selected outstanding functional element and performs only the task for the corresponding functional element until the project is completed.

In contrast, referring FIG. 12B, a second worker who does not have a previous project history for a plurality of functional elements participates in a project and performs, for initial N tasks, a task that is not divided into functional element units, when the performance of work for the initial N tasks is completed, and an outstanding functional element is selected on the basis of inspection results for work results of the N tasks, is assigned only a task for the selected outstanding functional element after a corresponding point in time, and performs only the task for the corresponding functional element unit the project is completed.

The server divides and pays a certain task unit price to a first worker or a second worker who performs a task for each of functional elements included in a task of a project.

In an embodiment, the server may pay each worker by dividing a task unit price into the number of functional elements.

For example, when one task includes three functional elements, and a task unit price is 1200 won, the server may pay a task unit price of 400 won to each of three workers who perform respective functional element unit tasks.

In another embodiment, the server may pay a task unit price to each worker in proportion to an average task performance time of each functional element unit task. The long average task performance time indicates a higher difficulty level, and thus, the server pays a larger amount of task unit price to a worker who performs a functional element unit task having a high difficulty level.

For example, when one task includes a first functional element, a second functional element, and a third functional element, average task performance times of a first functional element unit task, a second functional element unit task, and a third functional element unit task are 10 seconds, 30 seconds, and 20 seconds, respectively, and a task unit price is 1200 won, the server may respectively pay 200 won, 600 won, 400 won to three workers who respectively perform the first functional element unit task, the second functional element unit task, and the third functional element unit task.

In some embodiments of the present disclosure, although not clearly shown in FIGS. 3 through 11, a method of distributing functional element unit tasks of a crowdsourcing-based project may further include an operation of, when a first functional element unit task and a second functional unit task have a sequential performance order, accumulatively calculating, for each first worker, the number of inspection results that are input as rejections for a first functional element unit work result by an inspector and a giving a certain penalty to a first worker having the accumulatively calculated number exceeding a reference number.

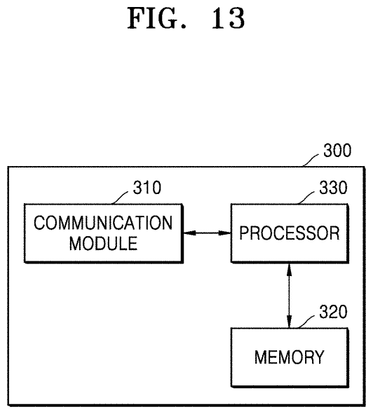

In the above description, according to an embodiment of the present disclosure, operations S11 through S250 may be further divided into additional operations or may be combined into sub-operations. Also, some operations may be omitted when needed or the order between operations may also be changed. In addition, even though the following description of FIG. 13 is omitted, the description may also be applied to a method of distributing functional element unit tasks of a crowdsourcing-based project described with reference to FIGS. 1 through 12.

Hereinafter, an apparatus 300 for distributing functional element unit tasks of a crowdsourcing-based project according to an embodiment of the present disclosure will be described with reference to FIG. 13.

FIG. 13 is a block diagram illustrating an apparatus for distributing functional element unit tasks of a crowdsourcing-based project, according to an embodiment of the present disclosure.

Referring to FIG. 13, an apparatus 300 for distributing functional element unit tasks of a crowdsourcing-based project (hereinafter, a task distribution apparatus) includes a communication module 310, a memory 320, and a processor 330.

The communication module 310 performs communication with a plurality of workers associated with one project, transmits a crowdsourcing-based task of the project to a plurality of workers 32 to request the performance of the task, and receives work results from the plurality of workers 32. The communication module 310 transmits, to a plurality of inspectors 34, the work results received from the plurality of workers 32 to request inspection, and receives inspection results from the plurality of inspectors 34.

The memory 320 stores data associated with a project, and stores a program for distributing a task in functional element units of a project according to an outstanding functional element of each worker, on the basis of data received from the communication module 310.

The processor 330 controls overall operation of the task distribution apparatus 300, and executes the program stored in the memory 320, for processing of an operation of distributing functional element unit tasks of the project.

The processor 330 may execute the program stored in the memory 320 to identify a plurality of functional elements included in a task of the project, and select, for each first worker, one outstanding functional element from among the plurality of functional elements included in the task of the project, on the basis of a previous project history of each first worker. Here, each first worker includes a worker who has a previous project history for the plurality of functional elements included in the task of the project.

After the outstanding functional element of each first worker is selected, the processor 330 may divide, for each task of the project, one task into a plurality of functional element units, and assign a plurality of functional element unit tasks obtained from the division to a plurality of first workers to request, via the communication module 310, the performance of the tasks, but may assign functional element unit tasks corresponding to the outstanding functional element to the plurality of first workers.

When a plurality of functional element unit work results for the functional element unit tasks are received from the plurality of first workers via the communication module 310, the processor 330 merges the plurality of functional element unit work results into one work result, requests one first inspector via the communication module 310 to perform inspection of the work result, and receives, from the first inspector via the communication module 310, an inspection result for the work result in a plurality of functional element units.

Here, upon assignment of the functional element unit tasks, when the plurality of functional element unit tasks have a sequential performance order, after the performance of a first functional element unit task of a higher priority is completed, the processor 330 may assign a second functional element unit task of a lower priority to request the performance of the task, and, when the plurality of functional element unit tasks do not have a sequential performance order, simultaneously may assign the plurality of functional element unit tasks to request the performance of the tasks.

Also, the processor 330 may assign each second worker N tasks (wherein N is a natural number greater than or equal to 1) that are not divided into a plurality of functional element units to request, via the communication module 310, the performance of the tasks. Here, each second worker may include a worker who does not have a previous project history for a plurality of functional elements included in a task of the project.

When work results of the assigned N tasks are received from each second worker via the communication module 310, the processor 330 may assign the work results of the N tasks to a plurality of inspectors to request, via the communication module 310, the performance of inspection, and, when inspection results for the work results of the N tasks are received in the plurality of functional element units from the plurality of inspectors via the communication module 310, select, for each second worker, an outstanding functional element from among the plurality of functional elements included in the task of the project, on the basis of the inspection results for the work results of the N tasks of each second worker.

After the outstanding functional element is selected for each second worker, the processor 330 may divide, for each task of the project, one task into the plurality of functional element units, and assign a plurality of functional element unit tasks obtained from the division to a plurality of second workers to request, via the communication module 310, the performance of the tasks, but may assign a functional element unit task corresponding to the outstanding functional element to each second worker.

When a plurality of functional element unit work results for the assigned functional element unit tasks are received from the plurality of second workers via the communication module 310, the processor 330 may merge the plurality of functional element unit work results into one work result, request one second inspector via the communication module 310 to perform inspection of the work result, and receive, from the second inspector via the communication module 310, an inspection result for the merged work result in a plurality of functional element units. Here, the first inspector and the second inspector may be the same person or different persons.

When selecting the outstanding functional element for each first worker, the processor 330 may calculate a rejection rate of each first worker for each of a plurality of functional elements included in a task of the project, on the basis of a previous project history of each first worker, and select, for each first worker, one outstanding functional element from among the plurality of functional elements included in the task of the project, on the basis of the calculated rejection rate.

Also, when selecting the outstanding functional element for each first worker, the processor 330 may select, for each first worker, one outstanding functional element from among the plurality of functional elements included in the task of the project by comparing percentile values of rejection rates of each first worker for each of the plurality of functional elements included in the task of the project.

In addition, upon selection of the outstanding functional element for each first worker, when percentile values of rejection rates of each first worker for each of a plurality of functional elements included in a task of the project includes a plurality of greatest values, the processor 330 may select, for each first worker, one outstanding functional element from among the plurality of functional elements included in the task of the project, further on the basis of the number of performed tasks of each first worker for each of the plurality of functional elements included in the task of the project.

Also, after the outstanding functional element is selected for each first worker, when an inspection result of the inspector for a particular functional element unit work result is a rejection, according to the inspection result for the work result, for each task of the project, the processor 330 may request, via the communication module 310, a first worker who inputs the rejected functional element unit work result to perform rework, from among each first worker.

In addition, when a first functional element unit task and a second functional element unit task have a sequential performance order, the processor 330 may accumulatively calculate, for each first worker, the number of rejections that are input as an inspection result for a first functional element unit work result by the inspector, and give a preset penalty to a first worker who has the accumulatively calculated number exceeding a reference number, from among each of the first workers.

Moreover, when selecting the outstanding functional element for each second worker, the processor 330 may calculate a rejection rate of each second worker for each of a plurality of functional elements included in a task of the project, on the basis of the inspection results for the work results of the N tasks of each second worker, and select, for each second worker, one outstanding functional element from among the plurality of functional elements included in the task of the project, on the basis of the calculated rejection rate.

Here, the N tasks include a plurality of verification tasks for each of a plurality of functional elements included in a task of the project, and, when selecting the outstanding functional element for each second worker, the processor 330 may calculate the number of incorrect performances of each second worker for each of a plurality of functional elements included in a task of the project, on the basis of a plurality of verification work results from among work results of the N tasks of each second worker, and select, for each second worker, one or more outstanding functional elements from among the plurality of functional elements included in the task of the project, on the basis of the number of incorrect performances of each second worker for each of the plurality of functional elements included in the task of the project.

Also, according to the present disclosure, a computer program may be stored in a medium to be combined with a computer that is hardware to execute a method of distributing functional element unit tasks of a crowdsourcing-based project. The computer program performs operations of: identifying a plurality of functional elements included in a task of a crowdsourcing-based project; selecting, for each first worker, one outstanding functional element from among the plurality of functional elements included in the task of the project, on the basis of a previous project history of each first worker, wherein each first worker includes a worker who has a previous project history for the plurality of functional elements included in the task of the project; after the outstanding functional element of each first worker is selected, dividing, for each task of the project, one task into a plurality of functional element units; assigning a plurality of functional element unit tasks obtained from the division to a plurality of first workers to request the performance of the tasks, wherein functional element unit tasks corresponding to the outstanding functional element are assigned to the plurality of first workers; when a plurality of functional element unit work results for the functional element unit tasks are received from the plurality of first workers, merging the plurality of functional element unit work results into one work result; requesting one first inspector to perform inspection of the work result; and receiving, from the first inspector, an inspection result for the work result in a plurality of functional element units, wherein the assigning the functional element unit tasks includes: when the plurality of functional element unit tasks have a sequential performance order, after performance of a first functional element unit task of a higher priority is completed, assigning a second functional element unit task of a lower priority to request performance of the task; and, when the plurality of functional element unit tasks do not have the sequential the performance order, simultaneously assigning the plurality of functional element unit tasks to request the performance of the tasks, and the computer program further performs operations: assigning each second worker N tasks (wherein N is a natural number greater than or equal to 1) that are not divided into a plurality of functional element units to request the performance of the tasks, wherein the each second worker includes a worker who does not have a previous project history for the plurality of functional elements included in the task of the project; when work results of the assigned N tasks are received from each second worker, assigning the work results of the N tasks to a plurality of inspectors to request the performance of inspection; when inspection results for the work results of the N tasks are received in the plurality of functional element units from the plurality of inspectors, selecting, for each second worker, an outstanding functional element from among the plurality of functional elements included in the task of the project, on the basis of the inspection results for the work results of the N tasks of each second worker; after the outstanding functional element is selected for each second worker, dividing, for each task of the project, one task into the plurality of functional element units; assigning a plurality of functional element unit tasks obtained from the division to a plurality of second workers to request the performance of the tasks, wherein a functional element unit task corresponding to the outstanding functional element is assigned to each second worker; when a plurality of functional element unit work results for the assigned functional element unit tasks are received from the plurality of second workers, merging the plurality of functional element unit work results into one work result; requesting one second inspector to perform inspection of the work result; and receiving, from the second inspector, an inspection result for the merged work result in a plurality of functional element units.

In other words, a computer program according to the present disclosure may be designed to process all operations of FIG. 13 associated with the distribution of functional element unit tasks of a crowdsourcing-based project.

Also, the task distribution apparatus 300 described with reference to FIG. 13 may be provided as a component of the server described above.

A method of distributing functional element unit tasks of a crowdsourcing-based project according to an embodiment of the present disclosure, as described above, may be implemented as a program (or an application) and stored in a medium to be combined with a computer that is hardware to be executed.

In order for the computer to read the program and execute the methods implemented as the program, the above-described program may include a code written in a computer language such as C, C++, JAVA, Ruby, and machine language that may be read by a processor (CPU) of the computer via a device interface of the computer. Such code may include functional code related to a function that defines functions needed for executing the above methods and the like, and may include execution procedure-related control code needed for the processor of the computer to execute the functions according to a preset procedure. Also, such code may further include memory reference-related code indicating a location (address) in an internal or external memory of the computer at which additional information or media needed for the processor of the computer to execute the functions may be referred to. Also, when the processor of the computer needs to communicate with any other computer or server at a remote location to execute the functions, the code may further include communication-related code indicating a method of communicating with any other computer or server at a remote location by using a communication module of the computer, and information or media that is transmitted and/or received during communication and the like.

The storage medium refers to a medium that stores data semi-permanently and may be read by a device, rather than a medium that stores data for a short moment, such as a register, a cache, or a memory. In detail, examples of the storage medium include ROM, RAM, CD-ROMs, magnetic tape, floppy disks, optical data storage devices, and the like but are not limited thereto. In other words, the program may be stored in various types of recording media on various servers that may be accessed by the computer or in various types of recording media on the computer of a user. Also, the media may be distributed over network-coupled computer systems so that computer-readable code is stored in a distributed fashion.

The foregoing description of the disclosure is for purposes of illustration, and those of ordinary skill in the art to which the disclosure pertains may understand that it may be easily modified into other specific forms without changing the technical spirit or essential features of the disclosure. Therefore, it may be understood that the embodiments described above are illustrative in all respects and not restrictive. For example, each element described as a single type may be implemented in a distributed manner, and likewise, elements described as being distributed may also be implemented in a combined form.

The scope of the disclosure is defined by the following claims, rather than by the above description, and all changes or modifications derived from the concept and scope of the claims and equivalents thereof may be construed as being included in the scope of the disclosure.

1. A method of distributing functional element unit tasks of a crowdsourcing-based project, performed by a computer, the method comprising:
identifying a plurality of functional elements included in a task of a crowdsourcing-based project;
on the basis of a previous project history of each of first workers, selecting, for each of first workers, one outstanding functional element from among the plurality of functional elements included in the task of the project, wherein each of the first workers includes a worker who has a previous project history for the plurality of functional elements included in the task of the project;
after the outstanding functional element of each of the first workers is selected, dividing, for each task of the project, one task into a plurality of functional element units;
assigning a plurality of functional element unit tasks obtained from the division to a plurality of first workers to request performance of the tasks, wherein functional element unit tasks corresponding to the outstanding functional element are assigned to the plurality of first workers;
when a plurality of functional element unit work results for the functional element unit tasks are received from the plurality of first workers, merging the plurality of functional element unit work results into one work result;
requesting one first inspector to perform inspection of the work result; and
receiving, from the first inspector, an inspection result for the work result in a plurality of functional element units, wherein
the assigning the functional element unit tasks includes:
when the plurality of functional element unit tasks have a sequential performance order, after performance of a first functional element unit task of a higher priority is completed, assigning a second functional element unit task of a lower priority to request performance of the task; and,
when the plurality of functional element unit tasks do not have the sequential performance order, simultaneously assigning the plurality of functional element unit tasks to request performance of the tasks, and
the method further includes: assigning each of second workers N tasks (wherein N is a natural number greater than or equal to 1) that are not divided into a plurality of functional element units to request performance of the tasks, wherein each of the second workers includes a worker who does not have a previous project history for the plurality of functional elements included in the task of the project;
when work results of the assigned N tasks are received from each of the second workers, assigning the work results of the N tasks to a plurality of inspectors to request performance of inspection;
when inspection results for the work results of the N tasks are received in the plurality of functional element units from the plurality of inspectors, selecting, for each of the second workers, an outstanding functional element from among the plurality of functional elements included in the task of the project, on the basis of the inspection results for the work results of the N tasks of each of the second workers;
after the outstanding functional element is selected for each of the second workers, dividing, for each task of the project, one task into the plurality of functional element units;
assigning the plurality of functional element unit tasks obtained from the division to a plurality of second workers to request performance of the tasks, wherein a functional element unit task corresponding to the outstanding functional element is assigned to each of the second workers;
when a plurality of functional element unit work results for the assigned functional element unit tasks are received from the plurality of second workers, merging the plurality of functional element unit work results into one work result;
requesting one second inspector to perform inspection of the work result; and
receiving, from the second inspector, an inspection result for the merged work result, in a plurality of functional element units.

2. The method of claim 1, wherein
the selecting, for each of the first workers, the outstanding functional element includes:
calculating a rejection rate of each of the first workers for each of the plurality of functional elements included in the task of the project, on the basis of the previous project history of each of the first workers; and
selecting, for each of the first workers, one outstanding functional element from among the plurality of functional elements included in the task of the project, on the basis of the calculated rejection rate.

3. The method of claim 2, wherein
the selecting, for each of the first workers, the outstanding functional element includes
selecting, for each of the first workers, one outstanding functional element from among the plurality of functional elements included in the task of the project by comparing percentile values of rejection rates of each of the first workers for respectively the plurality of functional elements included in the task of the project.

4. The method of claim 3, wherein
the selecting, for each of the first workers, the outstanding functional element includes,
when the percentile values of the rejection rates of each of the first workers for respectively the plurality of functional elements included in the task of the project include a plurality of greatest values, selecting, for each of the first workers, one outstanding functional element from among the plurality of functional elements included in the task of the project, further on the basis of a number of performed tasks of each of the first workers for each of the plurality of functional elements included in the task of the project.

5. The method of claim 1, further comprising:
after the outstanding functional element of each of the first workers is selected, when an inspection result of the inspector for a particular functional element unit work result is a rejection according to the inspection result for the work result, requesting a first worker who inputs the rejected functional element unit work result from among each of the first workers to perform rework.

6. The method of claim 5, further comprising:
when a first functional element unit task and a second functional element unit task have a sequential performance order,
accumulatively calculating, for each of the first workers, a number of rejections that are input as an inspection result for a first functional element unit work result by the inspector, and giving a preset penalty to a first worker who has the accumulatively calculated number exceeding a reference number, from among each of the first workers.

7. The method of claim 1, wherein
the selecting, for each of the second workers, the outstanding functional element includes:
calculating a rejection rate of each of the second workers for each of the plurality of functional elements included in the task of the project, on the basis of the inspection results for the work results of the N tasks; and
selecting, for each of the second workers, one outstanding functional element from among the plurality of functional elements included in the task of the project, on the basis of the calculated rejection rate.

8. The method of claim 1, wherein
the N tasks include a plurality of verification tasks for each of the plurality of functional elements included in the task of the project, and
the selecting, for each of the second workers, the outstanding functional element includes:
calculating a number of incorrect performances of each of the second workers for each of the plurality of functional elements included in the task of the project, on the basis of a plurality of verification work results from among the work results of the N tasks of each of the second workers; and
selecting, for each of the second workers, one or more outstanding functional elements from among the plurality of functional elements included in the task of the project, on the basis of the number of incorrect performances of each of the second workers for each of the plurality of functional elements included in the task of the project.

9. A non-transitory computer program stored in a medium to be combined with a computer that is hardware to execute a method of distributing functional element unit tasks of a crowdsourcing-based project, the computer program performing:
identifying a plurality of functional elements included in a task of a crowdsourcing-based project;
on the basis of a previous project history of each of first workers, selecting, for each of first workers, one outstanding functional element from among the plurality of functional elements included in the task of the project, wherein each of the first workers includes a worker who has a previous project history for the plurality of functional elements included in the task of the project;
after the outstanding functional element of each of the first workers is selected, dividing, for each task of the project, one task into a plurality of functional element units;
assigning a plurality of functional element unit tasks obtained from the division to a plurality of first workers to request performance of the tasks, wherein functional element unit tasks corresponding to the outstanding functional element are assigned to the plurality of first workers;
when a plurality of functional element unit work results for the functional element unit tasks are received from the plurality of first workers, merging the plurality of functional element unit work results into one work result;
requesting one first inspector to perform inspection of the work result; and
receiving, from the first inspector, an inspection result for the work result in a plurality of functional element units, wherein
the assigning the functional element unit tasks includes:
when the plurality of functional element unit tasks have a sequential performance order, after performance of a first functional element unit task of a higher priority is completed, assigning a second functional element unit task of a lower priority to request performance of the task; and
when the plurality of functional element unit tasks do not have the sequential performance order, simultaneously assigning the plurality of functional element unit tasks to request performance of the tasks, and
the computer program further performs: assigning each of second workers N tasks (wherein N is a natural number greater than or equal to 1) that are not divided into a plurality of functional element units to request performance of the tasks, wherein each of the second workers includes a worker who does not have a previous project history for the plurality of functional elements included in the task of the project;
when work results of the assigned N tasks are received from each of the second workers, assigning the work results of the N tasks to a plurality of inspectors to request performance of inspection;
when inspection results for the work results of the N tasks are received in the plurality of functional element units from the plurality of inspectors, selecting, for each of the second workers, an outstanding functional element from among the plurality of functional elements included in the task of the project, on the basis of the inspection results for the work results of the N tasks of each of the second workers;
after the outstanding functional element is selected for each of the second workers, dividing, for each task of the project, one task into the plurality of functional element units;
assigning the plurality of functional element unit tasks obtained from the division to a plurality of second workers to request performance of the tasks, wherein a functional element unit task corresponding to the outstanding functional element is assigned to each of the second workers;
when a plurality of functional element unit work results for the assigned functional element unit tasks are received from the plurality of second workers, merging the plurality of functional element unit work results into one work result;
requesting one second inspector to perform inspection of the work result; and
receiving, from the second inspector, an inspection result for the merged work result, in a plurality of functional element units.
